(19) United States
(12) Patent Application Publication
(10) Pub. No.: US 2010/0133359 A1
(43) Pub. Date: Jun. 3, 2010

(54) PROGRAMMABLY CONTROLLED LIQUID-FOOD DEPOSITOR MODULE

(76) Inventor: Giovanni GAETANO, Dublin, OH (US)

Correspondence Address: WINSTON & STRAWN LLP;PATENT DEPARTMENT, 1700 K STREET, N.W., WASHINGTON, DC, 20006, US

(21) Appl. No.: 12/326,073

(22) Filed: Dec. 1, 2008

(51) Int. Cl. A62C 31/02; B67D 5/06

(52) U.S. Cl. 239/392; 222/380

(57) ABSTRACT

Provided is a depositor module capable of dispensing a wide range of liquid foods having different dispensing specifications. The depositor module is adapted to draw liquid food from a pressurized product manifold or a hopper and dispense the liquid food. Further, the depositor module is adapted to deliver a broad range of liquid foods in different quantities and at different pressures for a variety of applications.

### TECHNOLOGY FIELD

The invention relates to an apparatus for dispensing liquid foods. The invention may be applicable in the preparation of ice cream products, confectionery products, frozen foods, and baked goods

### BACKGROUND

Liquid foods, such as chocolate, caramel, and fruit syrups, have different fluid characteristics that make them difficult to be dispensed by one type of device or delivery system. As a result, different types of liquid foods are traditionally dispensed by different devices having delivery systems specifically designed for the particular fluid characteristics of the liquid food to be dispensed. Further, in order to dispense a variety of liquid foods, production filling lines are configured with a variety of dispensing devices having different delivery systems. These dispensing devices take up substantial space on the filling line and are costly to purchase, install, and maintain. Additionally, some of the dispensing devices installed may not be used all the time as certain filing operations may not require all of the dispensing devices. Thus, it is not efficient to configure a filling line with a variety of dispensing devices that are not used all the time.

Alternatively, a filling line may be configured with only the dispensing devices needed for a particular filling operation. Such filling lines, however, are not very versatile because a change in filling operations requires a change in the dispensing devices configured on the filling line. The changeover of dispensing devices associated with one filling operation to dispensing devices associated with another filling operation is time consuming and costly. Thus, it is not efficient to configure a filling line with dispensing devices dedicated to only a particular filling operation.

In addition to accommodating various liquid food types, filling lines must be able to dispense these liquid foods in a variety of applications. For example, liquid foods may be streamed on a product, streamed inside a product, sprayed as a thin coating, or sprayed in a decorative pattern. These different applications require different delivery characteristics (e.g. spray v. stream, high pressure v. low pressure). As a result, conventional dispensing devices are designed for particular product applications. Thus, not only are conventional dispensing devices specifically designed for particular liquid foods, but also for particular applications

Another functional requirement of dispensing devices is accurate delivery of predetermined quantities of liquid foods. Accurate quantity delivery is important to maintain product consistency and avoid waste. Many conventional dispensing devices are time based (i.e. control quantity delivered by controlling time of delivery). Some of these time-based dispensing devices can be used with a variety of liquid foods, but are not very accurate because of the varying fluid characteristics of different liquid foods. Other time-based dispensing devices are more accurate in quantity delivery but are dedicated to only one product or one type of product. Accuracy of fluid delivery can translate into tens of thousands of dollars in cost savings per filling line during the course of a year.

There is a need for more versatile dispensing devices that can deliver a wider range of fluids in a variety of configurations with accuracy.

### SUMMARY

The invention relates to a depositor module capable of dispensing a wide range of liquid foods having different fluid characteristic, including viscosity, temperature requirement, particulate inclusion, and abrasiveness. The depositor module is adapted to draw liquid food from a pressurized product manifold or a hopper and dispense the liquid food. Further, the depositor module is adapted to deliver a broad range of liquid foods in different quantities and at different pressures for a variety of applications. In one embodiment, the depositor module comprises a first chamber and a second chamber that are connected by a passage. The first chamber includes an inlet and an outlet. Further, the depositor module operates between two states for charging liquid food into the depositor module and for discharging liquid food from the depositor module. In a first state, the inlet and the passage are open and the outlet is closed so that liquid food may flow in from the inlet, through the first chamber, and into the second chamber. In a second state, the inlet is closed and the passage and outlet are open so that liquid food may flow from the second chamber, through the first chamber, and out through the outlet.

In another embodiment, the depositor module may further include a valve disposed in the first chamber and piston disposed in the second chamber. The valve operates to allow liquid food to be charged into and discharged from the depositor module, and the piston operates to charge liquid food into the depositor module and discharge liquid food from the depositor module. The valve is configured to, in the first state, open the inlet and passage and close the outlet, and in the second state, close the inlet and open the passage and outlet. The piston is configured to, in the first state, create a negative pressure differential to pull liquid food from the inlet, through the first chamber, and into the second chamber, and in the second state, create a positive pressure differential to push liquid food from the second chamber, through the first chamber, and out through the outlet. In another embodiment, the operation of the valve and piston may be controlled and synchronized. Thus, the depositor module may further include a controller configured to control the operation of the valve and piston between the first and second states of operation.

### BRIEF DESCRIPTION OF THE FIGURES

Preferred features of the invention are now disclosed in the detailed description that follows, when considered with the appended drawing figures, wherein:

FIG. 1 shows a front view of an exemplary liquid food dispensing apparatus;

FIG. 2 shows a top view of the liquid food dispensing apparatus of FIG. 1;

FIG. 3 shows a side view of the liquid food dispensing apparatus of FIGS. 1 and 2;

FIG. 4 shows a front view of an exemplary product manifold;

FIG. 5 shows a side view of the product manifold of FIG. 4;

FIG. 6 shows a back view of an exemplary depositor module;

FIG. 7 shows a side view of the depositor module of FIG. 6;

FIG. 8 shows the depositor module of FIGS. 6 and 7 in a product charging state;

FIG. 9 shows the depositor module of FIGS. 6 and 7 in a product dispensing state;

FIG. 10 shows a side view of an exemplary actuator module;

FIG. 11 shows a front view of an exemplary rotation mechanism;

FIG. 12 shows a top view of the rotation mechanism of FIG. 11;

FIG. 13 shows a side view of the rotation mechanism of FIGS. 11 and 12;

FIG. 14 shows a side view of an exemplary telescoping tube;

FIGS. 15A-15D show different nozzles dispensing liquid food in different configurations;

FIGS. 16A-16D show different nozzles dispensing liquid food in different configurations;

FIGS. 17A-17D show different nozzles dispensing liquid food in different configurations.

### DETAILED DESCRIPTION OF THE PREFERRED EMBODIMENTS

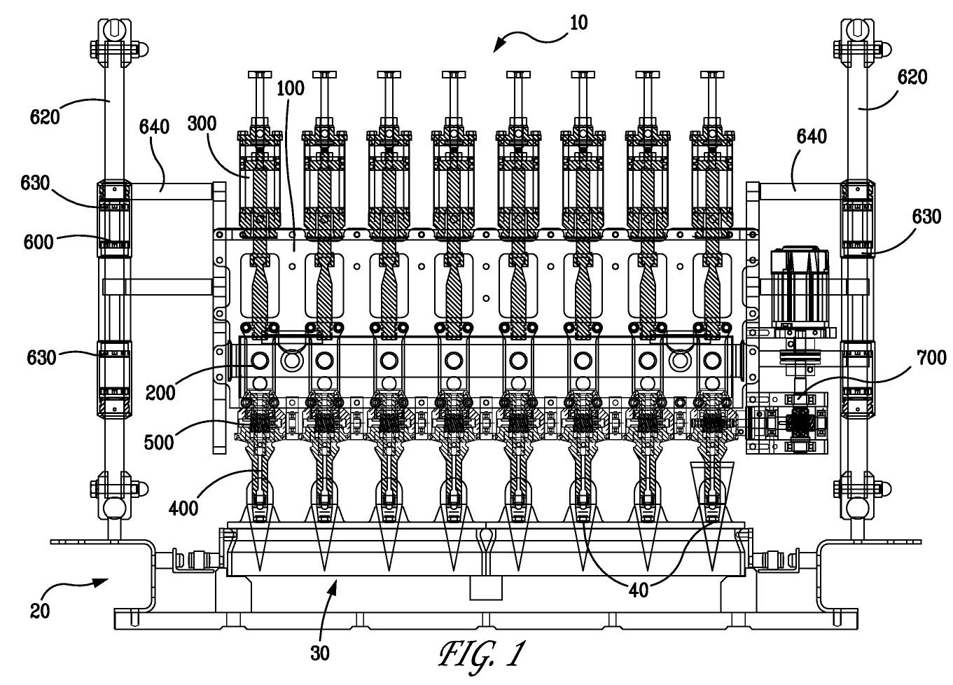

Although dispensing apparatus 10 will be described with regard to a preferred embodiment, the description is not intended limit the scope of the inventions recited in the claims of the application. In accordance with a preferred embodiment, as shown in FIGS. 1-3, dispensing apparatus 10 includes product manifold 100, depositor module 200, actuator module 300, nozzle 400, adapter 500, lift mechanism 600, and rotation mechanism 700. Preferably, dispensing apparatus 10 includes pressurized product manifold 100 that distributes a liquid food from a main source to individual depositor modules 200. Alternatively, a product hopper may be used instead of product manifold 100 to gravity feed the liquid food to individual depositor modules 200. As shown, multiple depositor modules 200 may be connected to product manifold 100 and arranged along the length of product manifold 100. Also, multiple actuator modules 300 may be supported on product manifold 100 and connected to depositor modules 200. Each actuator module 300 is operably connected to depositor module 200 to actuate the charging and discharging actions of depositor module 200. Connected to depositor modules 200 are nozzles 400 that dispense liquid food in different patterns. Nozzles 400 may be connected to depositor module 200 directly or by adapter 500 that is connected to depositor module 200. Adapter 500 allows nozzles having a variety of configurations to be connected to depositor module 200. Further, adapter 500 and be configured to allow nozzle 400 to spin.

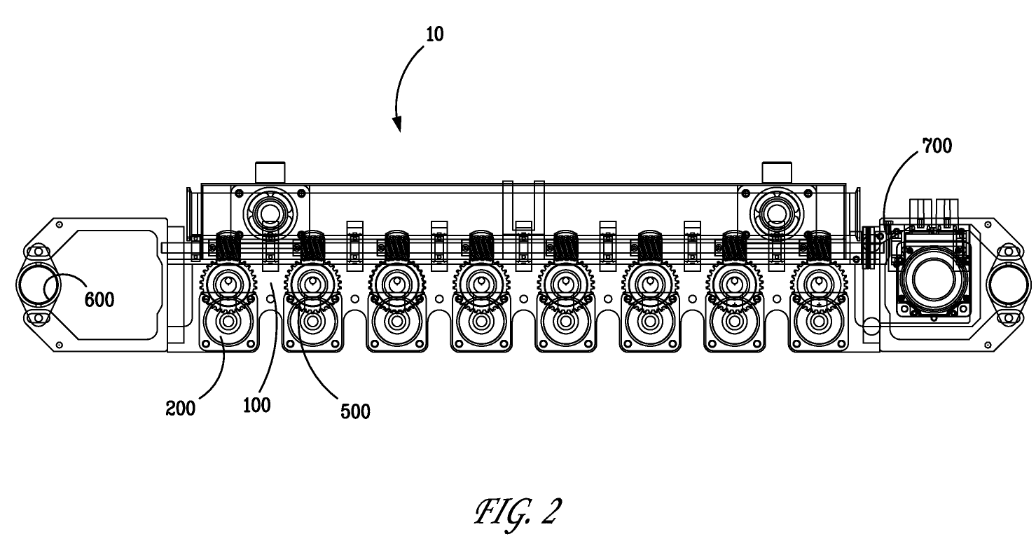

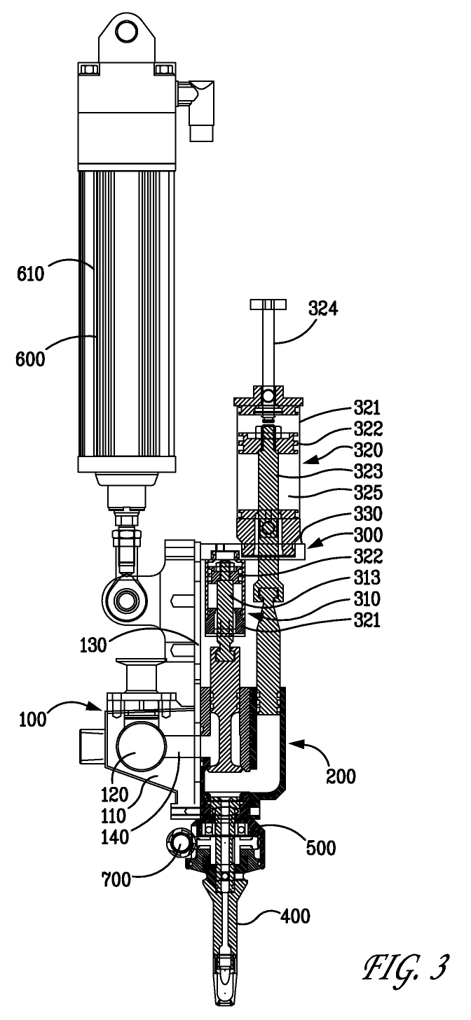

Dispensing apparatus 10 may further include lift mechanism 600 and rotation mechanism 700 to control the position of nozzles 400 dispensing liquid food. As shown in FIGS. 1 and 3, lift mechanism 600 may be attached to product manifold 100 to vertically translate dispensing apparatus 10 with respect to products 40 conveyed on filling line 20. In a preferred embodiment, product manifold 100 is connected on each side to bearings 630 that slide along vertical shaft 620 connected to the frame of filling line 20. Further, product manifold 100 is connected to bearings 630 on each side by pair of brackets 640. Dispensing apparatus 10 is designed to be lightweight so that lift mechanism 600 may vertically translate dispensing apparatus 10 at speeds of preferably greater than 1 m/s. As shown in FIG. 2, rotation mechanism 700 is supported on product manifold 100 and is operably connected to spinning adapters 500 holding nozzles 400 so that rotation mechanism 700 can actuate the spinning of nozzles 400. Together, lift mechanism 600 and rotation mechanism 700 may provide programmable control of the position of nozzles 400.

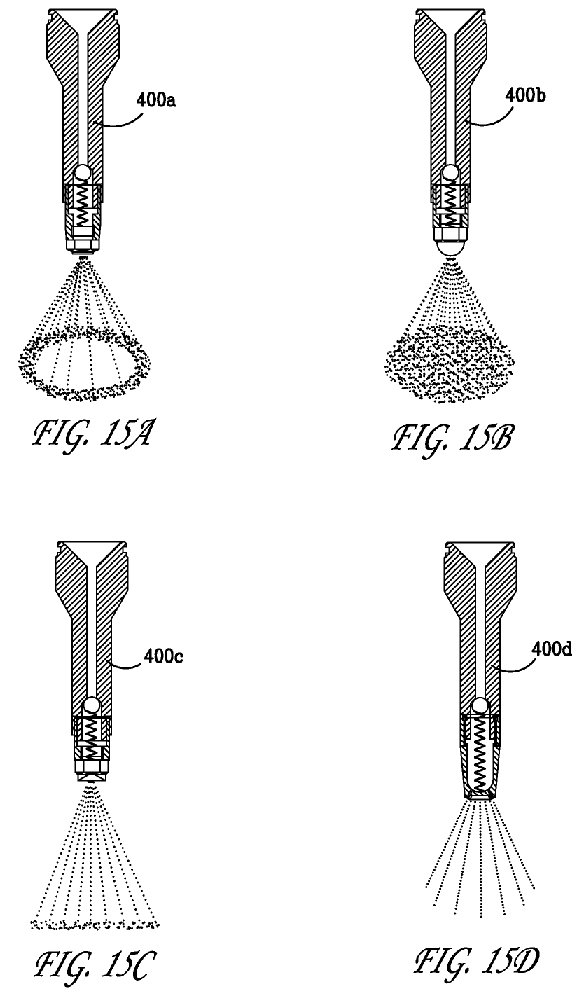

Dispensing apparatus 10 may be utilized with various liquid foods in different product applications. Further, nozzles 400 may be configured to have different delivery patterns to provide different product patterns or designs. For example, as shown in FIGS. 15A-15D, dispensing apparatus 10 may deliver a low-viscosity liquid food at high pressure through various atomizing nozzles 400 to provide different product patterns. FIG. 15A shows nozzle 400a spraying a liquid food through a small annular opening at high pressure to form a hollow cone pattern; FIG. 15 B shows another nozzle 400b spraying a liquid food through a small opening at high pressure to form a full cone pattern; FIG. 15C shows another nozzle 400c spraying a liquid food through a small slit at high pressure to form a flat web pattern; and FIG. 15D shows another nozzle 400d spraying a liquid food through multiple small openings at high pressure to form a multi-stream pattern. By moving nozzle 400 vertically, the hollow cone and full cone patterns may provide a thin coating of liquid food to the interior surface of a container (e.g. cone, cup, etc.). The flat web pattern may provide a thin coating of liquid food to the upper surface of a product (e.g. wafer, cake, etc.) moving on a conveyor. By moving nozzle 400 vertically, the multi stream pattern may provide a striped pattern to the interior surface of a container (e.g. cone, cup, etc.).

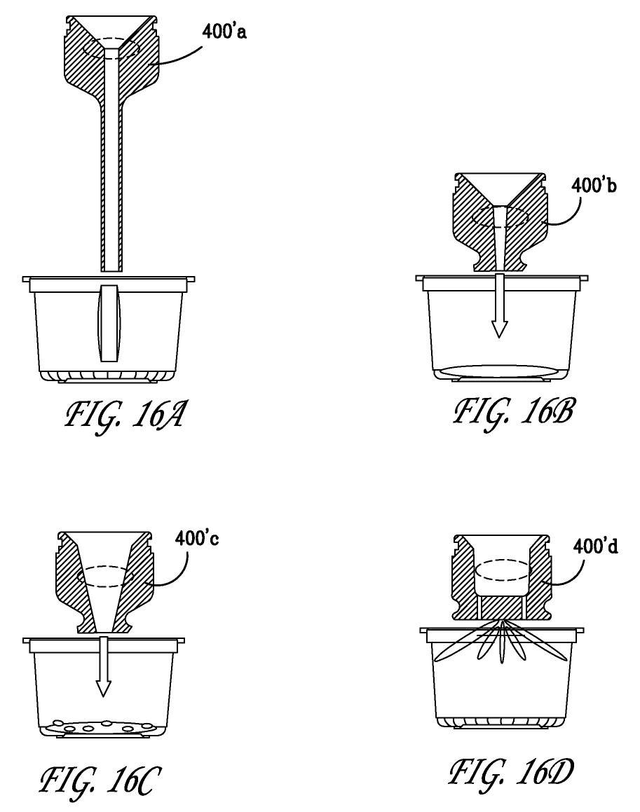

Also, as shown in FIGS. 16A-16D, dispensing apparatus 10 may deliver a high-viscosity liquid food at low pressure through various nozzles 400′ to provide different product patterns. For example, FIG. 16A shows nozzle 400′a dispensing a high-viscosity liquid at low pressure in the center of an ice cream product; FIG. 16B shows another nozzle 400′b dispensing a high-viscosity liquid food at low pressure at the bottom of a container (e.g. cone, cup, etc.); FIG. 16C shows another nozzle 400′c depositing a high-viscosity liquid food with particulates at low pressure at the bottom of a container; and FIG. 16D shows another nozzle 400′d dispensing a high-viscosity liquid food in multiple streams at low pressure on top of a product.

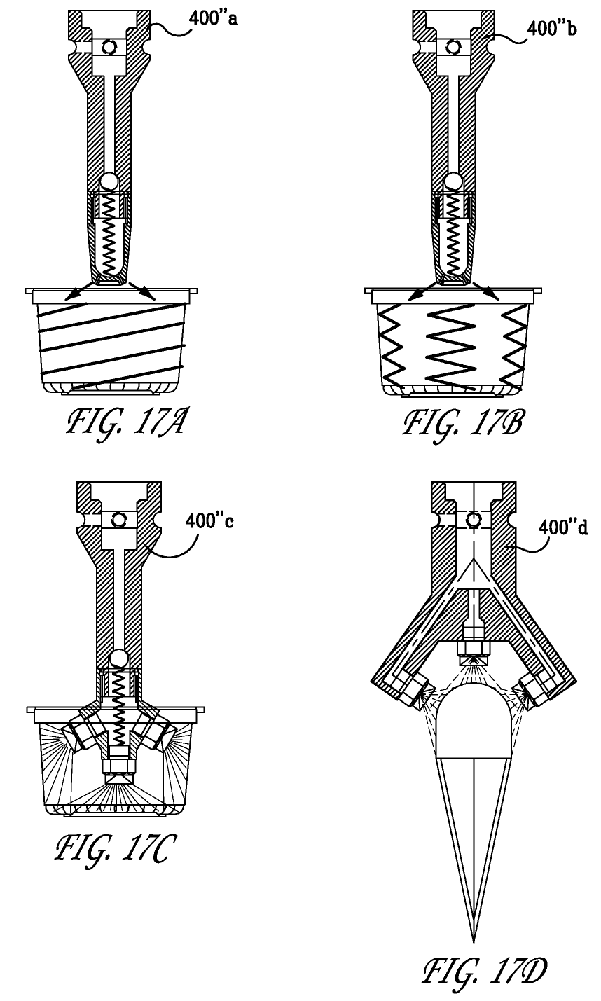

In addition to controlling the pressure of the liquid food, dispensing apparatus 10 may control the position of nozzles 400 to provide different product patterns. For example, as shown in FIGS. 17A-17D, various product patterns may be provided by using different nozzles 400″, controlling the vertical translation of nozzles 400″, and controlling the rotation of nozzles 400″. FIG. 17A shows nozzle 400″a providing a helical pattern on the interior of a container by dispensing a high-viscosity liquid food in two streams while vertically translating and rotating in synchronization. FIG. 17B shows another nozzle 400″b providing a zig-zag pattern on the interior of a container by dispensing a high-viscosity liquid food in multiple streams while vertically translating and rotationally oscillating in synchronization. FIG. 17C shows another nozzle 400″c coating the interior of a container by outwardly spraying a low-viscosity liquid food in multiple streams while vertically translating and rotating. FIG. 17D shows another nozzle 400″d coating the exterior of a food product by inwardly spraying a low viscosity liquid food in multiple streams while vertically translating and rotating.

The individual components, modules, and mechanism of dispensing apparatus 10 are described in more detail below. Again, these descriptions are made with regard to preferred embodiments and are not intended to limit the scope of the particular inventions recited in the claims of the application.

### Product Manifold

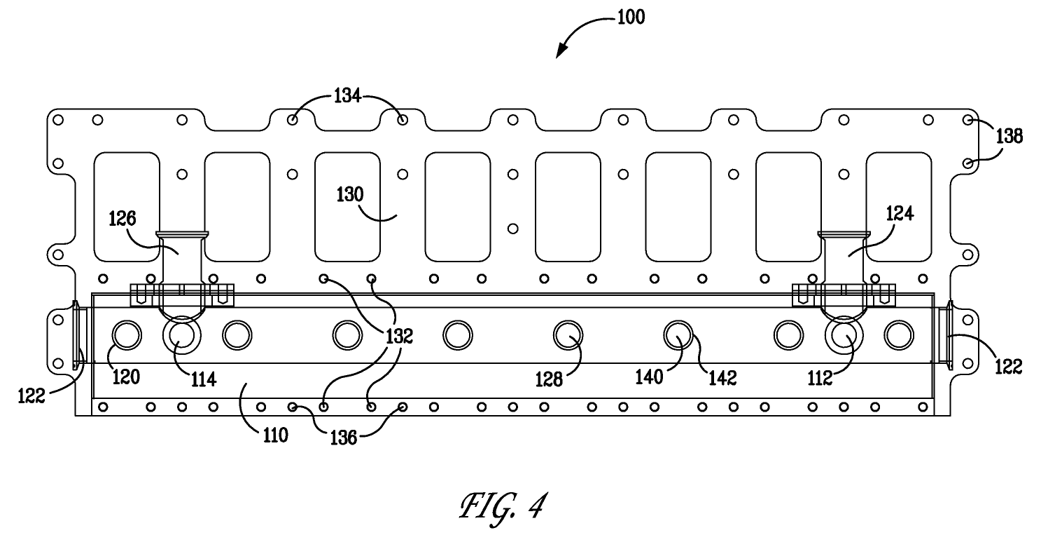

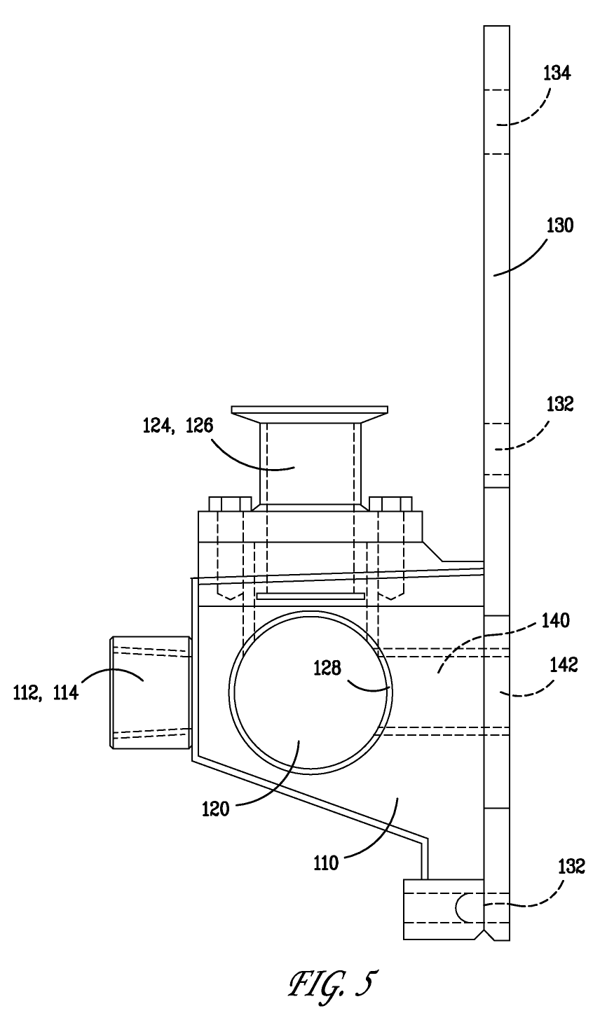

Product manifold 100 serves multiple functions, including: receiving the liquid food and distributing it to one or more depositor modules 200; maintaining the liquid food within a specified temperature range; and supporting the components, modules, and mechanisms of dispensing apparatus 10. Product manifold 100 is preferably constructed of stainless steel for easy cleaning and sanitation. FIGS. 4 and 5 show a preferred embodiment of product manifold 100. Product manifold 100 comprises fluid-jacket chamber 110, product distribution tube 120, and mounting interface 130.

Fluid-jacket chamber 110 includes inlet 112 and outlet 114 that may be connected to a source of temperature-controlled fluid (not shown) and a pump (not shown) so that the temperature-controlled fluid may be circulated throughout fluid-jacket chamber 110. As shown in FIG. 4, fluid-jacket chamber 110 preferably extends the length of product manifold 100 so that the temperature of product manifold 100 and elements in thermal contact with product manifold 100 may be controlled. Fluid jacket chamber 110 is preferably tall and wide enough to properly provide heat transfer to all of depositor modules 200 connected to product manifold 100. Fluid jacket 110 can be used to warm or cool the temperature of product manifold 100 and the liquid food. For example, a fluid may be circulated through fluid-jacket chamber 110 at about 120 F to prevent chocolate syrup from clogging of the components of dispensing apparatus 10.

As shown in FIGS. 4 and 5, product distribution tube 120 is disposed inside fluid-jacket chamber 110 and preferably extends through fluid jacket chamber 110 along the length of product manifold 100. Product distribution tube 120 preferably has an internal diameter of about 2 inches to allow liquid foods with particulates to flow easily and to allow easy cleaning. Further, product distribution tube 120 is preferably an open-ended tube that extends through fluid-jacket chamber 110 so that the ends of product distribution tube 120 are open to the outside of product manifold 100. The open ends of product distribution tube 120 are preferably capped with removable caps 122 that provide a hermetic seal. End caps 122 of product distribution tube 120 may be removed to easily clean and sanitize the surfaces of product manifold 100 that come into contact with the liquid food.

In a preferred embodiment, product distribution tube 120 defines inlet 124, outlet 126, and plurality of openings 128. The plurality of openings 128 in product distribution tube 120 are each connected to product port 140 that is open to the outside of product manifold 100. In a preferred embodiment, openings 128 and product ports 140 preferably have a large internal diameter of about 0.875 inches to allow viscous liquid foods with particulates to flow easily. As best seen in FIG. 5, fluid-jacket chamber 110 preferably encapsulates the lengths of product distribution tube 120 and product ports 140 to control the temperature of the liquid food in product manifold 100. Inlet 124 and outlet 126 are connected to a source of pressurized liquid food (e.g. tank or pump) so that the liquid food may be circulated through product distribution tube 120 and distributed through the plurality of product ports 140. Inlet 124 and outlet 126 may be connected to the source of pressurized liquid food (e.g. tank or pump) by a flexible hose or a telescoping fluid-jacketed supply tube 700 (described in more detail below).

Referring to the preferred embodiment of FIGS. 4 and 5, mounting interface 130 of product manifold 100 is preferably in thermal contact with fluid-jacket chamber 110. Also, mounting interface 130 preferably has a wide and smooth milled surface for good thermal conductivity. Further, product ports 140 of product manifold 100 define openings 142 in mounting interface 110 so that liquid food may be distributed to depositor modules 200 connected to mounting interface 130. Mounting interface 130 includes a plurality of mounting features 132, 134, 136, 138 for quickly connecting and disconnecting various components of dispensing apparatus 10 to product manifold 100. As shown in the preferred embodiment, mounting features 132, 134, 136, 138 may be holes in product manifold 100 for receiving fasteners such as bolts or screws. Although mounting features 132, 134, 136, 138 in the preferred embodiment are holes, one skilled in the art will recognize that other mounting features, such as brackets, latches, etc., may be employed.

As shown in FIG. 4, product manifold 100 provides depositor module mounting features 132, actuator module mounting features 134, rotation mechanism mounting features 136, and bracket mounting features 138. Depositor mounting features 132 are preferably positioned so that depositor modules 200 may be connected to product ports 140 and placed in thermal contact with fluid-jacket chamber 110. Actuator module mounting features 134 are preferably positioned so that actuator modules 300 may be mounted adjacent and operably connected to depositor module 200. Rotation mechanism mounting features 136 are preferably positioned so that rotation mechanism 600 may be mounted adjacent and operably connected to depositor modules 200. Bracket mounting features 138 are configured to connect product manifold 100 to bearings 530 to allow dispensing apparatus 10 to translate vertically with respect to filling line 20.

### Depositor Module

In a preferred embodiment shown in FIG. 3, depositor module 200 is connected to pressurized product manifold 100 to receive liquid food, but may be connected to a product hopper (not shown) instead. As shown in FIG. 1, multiple depositor modules 200 may be mounted and connected to product manifold 100. In the preferred embodiment, there are eight depositor modules 200 in dispensing apparatus 10. Each depositor module 200 draws liquid food from product manifolds 100 or hopper (not shown) and dispenses the liquid food to product 40. As shown in FIG. 1, products 40 to be prepared can be arranged in multiple lanes on conveyor 30 and presented below dispensing apparatus 10 in a row so that multiple products 40 may be prepared simultaneously.

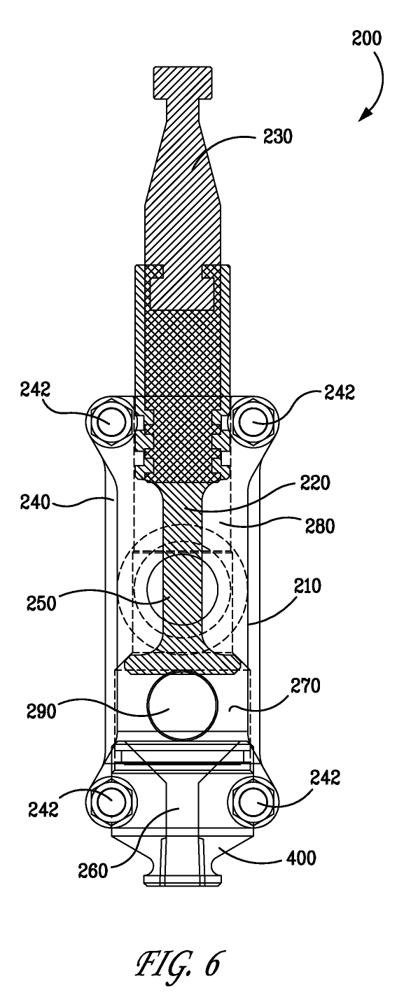

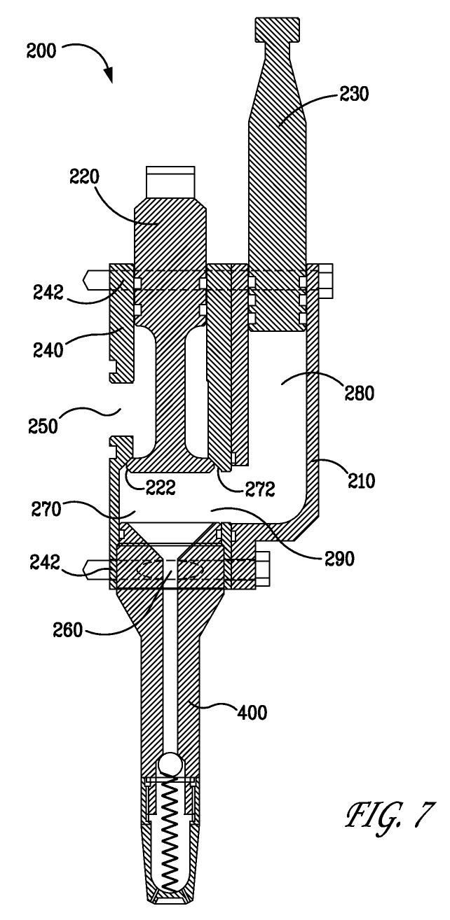

Depositor module 200 can deliver a broad range of liquid foods in different quantities and at different pressures. Further, depositor modules 200 may be programmably controlled to deliver discrete quantities of liquid food at predetermined pressures. The basic configuration of depositor module 200 shown in FIGS. 6-9 can deliver a wide range of fluids in a variety of applications. In a preferred embodiment, depositor module 200 comprises body 210, valve 220, and piston 230. Valve 210 operates to allow liquid food to be charged into and discharged from depositor module 200. Piston 230 operates to charge liquid food into and discharge liquid food from depositor module 200. Body 210, valve 220, and piston 230 of depositor module 200 are adapted to be easily disassembled for cleaning, maintenance, or replacement. Also, body 210, valve 220, and piston 230 are preferably made of materials that can resist the abrasive characteristics of some liquid foods, such as chocolate compounds. Further, body 210, valve 220, and piston 230 are preferably made of materials that can tolerate the sanitary dairy wash down environment.

In accordance with a preferred embodiment shown in FIGS. 6-9, body 210 of depositor module 200 defines exterior mounting interface 240, inlet 250, outlet 260, first internal chamber 270, and second internal chamber 280. mounting interface 240 of depositor module 200 preferably is flat and is mounted flush against mounting interface 130 of product manifold 100 so that there is good heat transfer between fluid-jacket chamber 110 of product manifold 100 and depositor module 200. Also, mounting interface 240 includes mounting features 242 configured to cooperate with depositor module mounting features 132 of product manifold 100. Further, mounting features 240 are adapted to receive fasteners (e.g. bolts, screws, etc.) to attach depositor module 200 to product manifold 100 and connect inlet 250 of depositor module 200 with product port 140 of product manifold 100. As shown, in a preferred embodiment, mounting features 242 may be holes in depositor module 200 configured to align with holes 132 in product manifold 100 to receive fasteners for mounting depositor module 200 to product manifold 100. The fasteners can be removed to easily allow the entire depositor module 200 to be disconnected from product manifold 100. Although mounting features 242 in the preferred embodiment are holes for receiving fasteners, one skilled in the art will recognize that other mounting features, such as brackets, latches, etc., may be employed.

In a preferred embodiment, as shown in FIGS. 6-9, inlet 250 extends from mounting interface 240 to first chamber 270 and outlet 260 extends from first chamber 270 to the exterior of body 210. The dimensions of first and second chambers 270, 280 may be configured to accommodate various volumetric requirements for particular liquid foods and applications. Inlet 270 is adapted to connect with product port 140 of product manifold 100 and provide a sealed connection for the liquid food to flow through. Outlet 280 is adapted to removably connect nozzle 400 or adapter 500 for attaching nozzle 400. First and second chambers 270, 280 are connected by passage 290 so that liquid food can flow between first and second chambers 270, 280. Preferably, passage 290 is sized to allow viscous liquids with particulates to flow easily. First chamber 270 accommodates valve 220 that operates to open and close access to inlet 250 and outlet 260. Second chamber 280 accommodates piston 230 that operates to charge and discharge liquid food into and out of body 210 of depositor module 200.

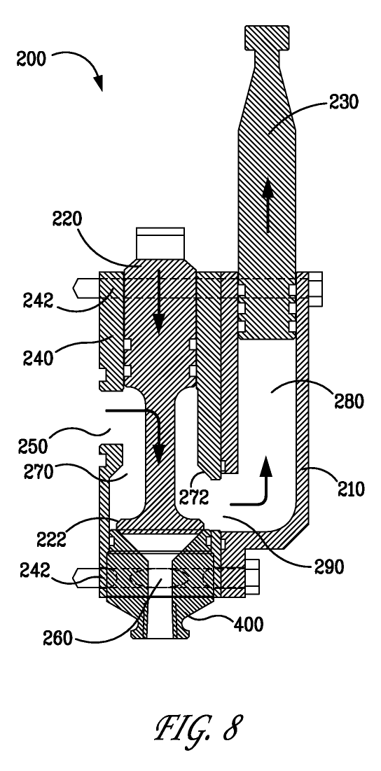

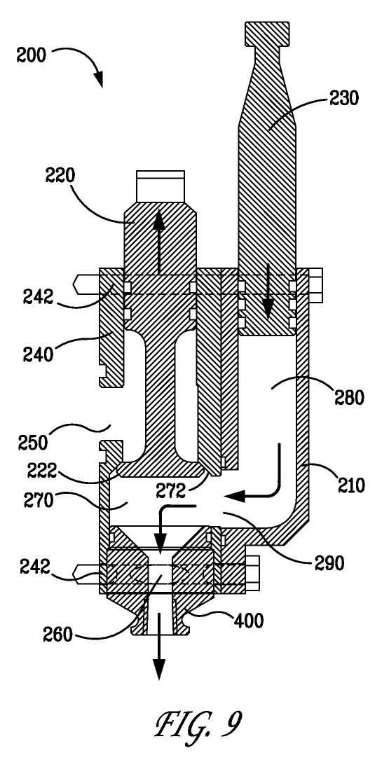

In a preferred embodiment shown in FIG. 6-9, valve 220 is a dynamic check valve that is moveable between two positions. In a first position, as shown in FIG. 8, valve 220 closes off outlet 260 and opens up inlet 250 to first and second chambers 270, 280 so that liquid food can flow from product manifold 100 through inlet 250 and into first and second chambers 270, 280. In a second position, as shown in FIG. 9, valve 220 closes off inlet 250 and opens up outlet 260 to first and second chambers 270, 280 so that the liquid food can flow out from first and second chambers 270, 280 through outlet 260. In a preferred embodiment, valve 220 has a port sized to allow viscous liquids with particulates to pass. Further, valve 200 and first chamber 270 are adapted to provide good seals against high pressure fluids when either inlet 250 or outlet 260 is closed off. For example, as shown in FIGS. 8 and 9, surfaces 222, 272 of first chamber 270 and valve 220 that come into contact to close off inlet 250 and outlet 260 are angled to increase the contact surface area and provide a good seal against high pressure fluids. Although the preferred embodiment employs valve 220, it will be apparent to those skilled in the art that other mechanisms may be used instead to provide the same function.

In a preferred embodiment shown in FIGS. 6-9, piston 230 is adapted to slidably translate inside second chamber 280 of body 210 of depositor module 200. As shown in FIG. 8, piston 230 may retract from an extended position to create a vacuum and charge first and second chambers 270, 280 with liquid food. The amount of liquid food that is drawn into body 210 of depositor module 200 may be controlled by controlling the translation of piston 230 as it retracts from second chamber 280. Thus, the greater the distance that piston 230 translates as it retracts, the greater the volume of liquid food that will be drawn into the body 210 of depositor module 200. Because piston 230 creates a volumetric vacuum inside the body 210 of depositor module 200, the liquid food may be drawn from either a pressurized product manifold 100 or a product hopper (not shown). Subsequently, as shown in FIG. 9, piston 230 can extend into second chamber 280 and discharge the liquid food. The pressure of the liquid food being discharged may be controlled by controlling the force with which piston 230 extends into second chamber 280. Thus, the greater the force with which piston 230 extends into second chamber 280, the greater the pressure with which the liquid food will be discharged.

As described, the translation of piston 230 in second chamber 280 may be controlled with respect to distance and force so that depositor module 200 can deliver particular quantities of liquid food at particular pressures. Also, the dimensions of second chamber 280 and piston 230 may be configured to accommodate various volumetric and pressure requirements for particular liquid foods and applications. The volumetric vacuum produced by the motion of piston 230 allows depositor module 200 to deliver a desired quantity of liquid food accurately within +/−0.2 grams. Further, piston 230 produces enough internal pressure to atomize liquid foods through a nozzle. Although the preferred embodiment employs piston 230, it will be apparent to those skilled in the art that other mechanisms may be used instead to provide the same function.

### Actuator Module and Controllers

In a preferred embodiment, the operation of valve 220 and piston 230 in depositor module 200 may be actuated by actuator module 300. As shown in FIGS. 1 and 3, actuator module 300 is preferably mounted on product manifold 100 and connected to depositor module 200 in dispensing apparatus 10. As shown in FIG. 3, mounting platform 330 may include mounting features 332 for quickly connecting and disconnecting actuator module 300 to product manifold 100. As shown, mounting features 332 may be holes for receiving fasteners such as bolts or screws. Additionally, mounting features 332 are configured to be aligned with actuator module mounting features 134 of product manifold 100 and receive fasteners for attaching actuator module 300 to product manifold 100. Mounting features 332 are preferably configured so that actuator module 300 may be mounted adjacent and operably connected to depositor module 200. Although mounting features 332 in the preferred embodiment are holes for receiving fasteners, one skilled in the art will recognize that other mounting features, such as brackets, latches, etc., may be employed.

In a preferred embodiment shown in FIGS. 1, 3, and 10, actuator module 300 includes valve actuator 310, piston actuator 320, mounting platform 330, and controller (not shown). Thus, as shown in FIGS. 1 and 3, the operation of valve 220 and piston 230 in depositor module 200 may be actuated and synchronized by valve and piston actuators 310, 320, respectively, which may be controlled by one or more programmable logic controllers (not shown). As shown, valve and piston actuators 310, 320 are preferably mounted on the same mounting platform 330. By having valve and piston actuators 310, 320 mounted on the same mounting platform 330, the overall size and weight of the actuator module 300 is reduced. Further, because mounting platform 330 is in thermal contact with product manifold 100 and actuator module 300 is connected to depositor module 200, heat transfer to depositor module 200 is increased.

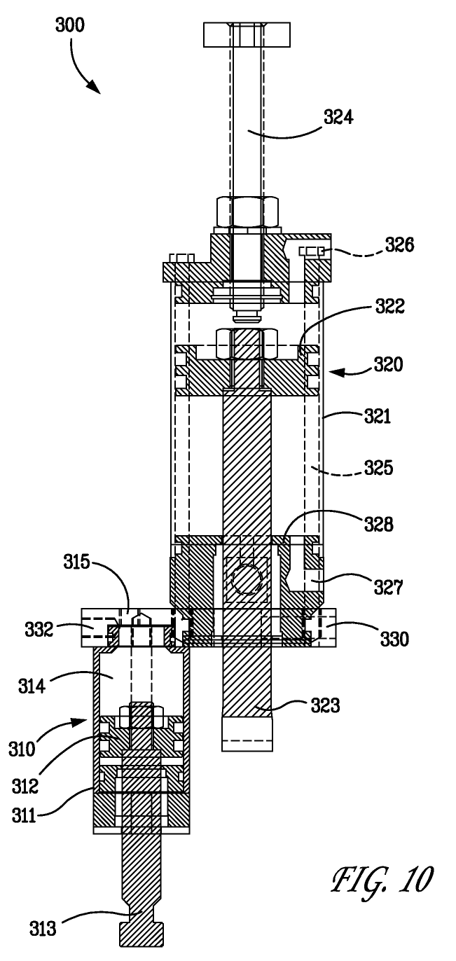

Referring to FIG. 10, in a preferred embodiment, valve actuator 310 may be a pneumatic linear actuator comprising cylindrical body 311, piston 312, and coupler 313. Cylindrical body 311 defines a chamber 314 and a port 315 into chamber 314. Piston 312 is disposed in chamber 314 and sealed against the surface of chamber 314. Further, piston 314 is adapted to translate back and forth inside chamber 314 as pressurized fluid flows in and out of chamber 314 through port 315. Coupler 313 is connected to piston 312 and extends outside chamber 314 to connect to valve 220. Preferably, coupler 313 is a quick-release coupler so that depositor and actuator modules 200, 300 may be easily disconnected from each other and removed from product manifold 100 for cleaning, maintenance, or replacement. As shown, coupler 313 extends through bearing seal 316 disposed around an opening in chamber 314 such that a portion of coupler 313 may translate in and out of cylindrical body 311 as piston 312 translates back and forth inside chamber 314. Thus, as piston 312 translates back and forth inside chamber 314, valve 220 opens and closes. Although valve actuator 310 has been described with regard to a preferred embodiment, as may be apparent to one skilled in the art, other structures or configurations may be suitable for moveably connecting product manifold 100 of dispensing apparatus 10 to filling line 20.

Again referring to FIG. 10, in a preferred embodiment, piston actuator 320 is a pneumatic linear actuator. As shown, piston actuator 320 preferably comprises cylindrical body 321, piston 322, coupler 323, and stroke-adjustment member 324. Cylindrical body 321 defines chamber 325 and upper and lower ports 326, 327 into chamber 325. Piston 322 is disposed in chamber 325 and sealed against the surface of chamber 325. Further, piston 322 is adapted to translate back and forth inside chamber 325 as pressurized fluid flows in and out of chamber 325 through upper and lower ports 326, 327. Coupler 323 is connected to piston 322 and extends outside chamber 325 to connect to piston 230. Preferably, coupler 323 is a quick-release coupler so that depositor and actuator modules 200, 300 may be easily disconnected from each other and removed from product manifold 100 for cleaning, maintenance, or replacement. As shown, coupler 323 extends through bearing seal 328 disposed around an opening in chamber 325 such that a portion of coupler 323 may translate in and out of cylindrical body 321 as piston 322 translates back and forth inside chamber 325. Thus, as piston 322 translates back and forth inside chamber 325, piston 230 charges and discharges liquid food into and out of depositor module 200. Stroke-adjustment member 324 is adapted to control the stroke length of piston 322. As shown, stroke-adjustment member 324 may be configured to adjustably extend into chamber 325 to increase or decrease the stroke length of piston 322. Thus, stroke-adjustment member 324 may control the volume of liquid food charged into and discharged out of depositor module 200.

Pneumatic piston actuator 320 preferably operates in a range of about 20 PSI to 100 PSI so that piston 230 can create enough chamber pressure to atomize liquid foods through nozzle 400. In order to maximize the chamber pressure created by piston 230, the piston ratio between piston 322 and piston 230 must be maximized. The piston ratio is the ratio of the cross sectional areas of piston 322 and piston 230. For example, if the cross sectional area of piston 322 is 2,827 mm² and the cross-sectional area of piston 230 is 452 mm², the piston ratio is about 6.25 (2,827 mm²/452 mm²). If the piston ratio is 6.25 and piston 322 operates, for example, at a pressure of 100 PSI, then piston 230 will operate at a pressure of 625 PSI. Thus, in a preferred embodiment the cross sectional are of piston 322 is greater than the cross-sectional area of piston 230. Further, in order to atomize liquid food for certain applications, liquid food must not only be discharged through nozzle 400 with high pressure, but also high speed. Thus, piston actuator 320 must actuate piston 230 with high speed as well as high force. In a preferred embodiment, pneumatic piston actuator 320 is adapted for fast motion so that depositor module 200 may perform at least 60 dispensing operations per minute. For example, upper and lower ports 326, 327 have large dimensions to maximize the flow of pressurized fluid in chamber 325 so that the speed with which piston 322 moves inside chamber 325 is maximized. Although piston actuator 320 has been described with regard to a preferred embodiment, as may be apparent to one skilled in the art, other structures or configurations may be suitable for moveably connecting product manifold 100 of dispensing apparatus 10 to filling line 20.

In a preferred embodiment, valve and piston actuators 310, 320 may be connected to one or more programmable logic controllers (not shown) that synchronize the timing of valve 220 and piston 230 operations. For example, in FIG. 8, valve actuator 310 may be controlled to actuate valve 220 of depositor module 200 to close off outlet 260 and open up inlet 250 to first and second chambers 270, 280 while piston actuator 320 may be controlled to actuate piston 230 to retract and create a vacuum so that liquid food can flow from product manifold 100 into first and second chambers 270, 280. In FIG. 9, for example, valve actuator 310 may be controlled to actuate valve 220 to close off inlet 250 and open up outlet 260 to first and second chambers 270, 280 while piston actuator 320 may be controlled to actuate piston 230 to extend and discharge the liquid food from first and second chambers 270, 280 through outlet 260.

Further, as products having different configurations require different liquid food quantities and pressures, piston actuator 320 may be controlled so that depositor module 200 may deliver different quantities of liquid food at different pressures. As described above in connection with depositor module 200, the quantity and pressure of the liquid food to be dispensed can be controlled by controlling the distance that piston 230 translates and the force with which it translates. For example, a relatively small quantity of chocolate may be atomized through a spray nozzle at 500 PSI while a relatively large quantity of fruit syrup may be deposited at 20 PSI Thus, for the chocolate example, piston actuator 320 may be controlled to actuate piston 230 for a relatively short distance with a relatively high force. In contrast, for the fruit syrup example, piston actuator 320 may be controlled to actuate piston 230 for a relatively long distance with a relatively low force.

Additionally, actuator module 300 may be programmed to provide depositor module 200 with a suck-back function. When trying to dispense very sticky and viscous liquid foods in consistent patterns, the stream of liquid food may form strings that need to broken by sucking back the liquid food into depositor module 200. Thus, actuator module 300 may be programmed to provide a suck-back function that actuates piston 230 of depositor module 200 to retract and suck back the liquid food before the next depositing cycle begins.

### Nozzle and Adapter

Different products may require liquid food to be dispensed in different modes and in specific patterns or designs to achieve a desired product configuration. As a result, dispensing apparatus 10 may be equipped with nozzles 400 having different delivery patterns to provide a desired product configuration. For example, FIG. 15A shows nozzle 400a spraying a liquid food through a small annular opening at high pressure to form a hollow cone pattern; FIG. 15 B shows another nozzle 400b spraying a liquid food through a small opening at high pressure to form a full cone pattern; FIG. 15C shows another nozzle 400c spraying a liquid food through a small slit at high pressure to form a flat web pattern; and FIG. 15D shows another nozzle 400d spraying a liquid food through multiple small openings at high pressure to form a multi-stream pattern. For example, FIG. 16A shows nozzle 400′a dispensing a high-viscosity liquid through a long thin tube at low pressure in the center of an ice cream product; FIG. 16B shows another nozzle 400′b dispensing a high-viscosity liquid food through a small opening at low pressure at the bottom of a container (e.g. cone, cup, etc.); FIG. 16C shows another nozzle 400′c depositing a high-viscosity liquid food with particulates through a large opening at low pressure at the bottom of a container; and FIG. 16D shows another nozzle 400′d dispensing a high-viscosity liquid food through multiple openings at low pressure on top of a product.

Thus, a variety of nozzles 400 having different numbers and shapes of openings to produce different patterns may be used. Nozzles 400 may be releasably connected directly to outlet 260 of depositor module 200 or adapter 500 may be provided for releasably connecting nozzle 400 to outlet 260 of depositor module 200. Adapter 500 may be necessary to connect nozzle 400 to outlet 260 of depositor module 200 because all nozzles 400 may not be configured the same and may not have the proper configuration to connect to outlet 260. Thus, adapter 500 may be attached to outlet 260 of depositor module 200 for connecting a wide range of nozzle 400 configurations. Further, in a preferred embodiment, adapter 500 is adapted to spin nozzle 400. Adapter 500 may include gear 510, preferably a worm gear that is supported inside adapter 500 by roller bearings 520 so that it can rotate about a vertical axis. Further, gear 510 is adapted to engage drive mechanism 700, preferably a worm drive. adapter 500 is configured to connect to nozzle 400 such that nozzle 400 is rotationally fixed with respect to gear 510 but is free to rotate with respect to adapter 500 about a vertical axis. Drive mechanism 700 engages and drives gear 510 of adapter 500 to rotate nozzle 400. Further, if drive 700 operates in two directions, nozzle 400 may be rotated in a clockwise direction, a counterclockwise direction, or alternate between clockwise and counterclockwise directions.

For example, as shown in FIGS. 17A-17D, various product patterns may be provided by using different nozzles 400 and controlling the vertical translation and rotation of nozzles 400. FIG. 17A shows nozzle 400″a providing a helical pattern on the interior of a container by dispensing a high-viscosity liquid food in two streams while vertically translating and rotating in synchronization. FIG. 17B shows another nozzle 400″b providing a zigzag pattern on the interior of a container by dispensing a high-viscosity liquid food in multiple streams while vertically translating and rotationally oscillating in synchronization. FIG. 17C shows another nozzle 400″c coating the interior of a container by outwardly spraying a low-viscosity liquid food in multiple streams while vertically translating and rotating. FIG. 17D shows another nozzle 400″d coating the exterior of a food product by inwardly spraying a low viscosity liquid food in multiple streams while vertically translating and rotating.

### Lift Mechanism

As discussed above, some product configurations may require vertical translation of nozzle 600 with respect to a product. Thus, lift mechanism 600 may be provided to vertically translate dispensing apparatus 10 and its depositor modules 20 over the products on a filling line. In a preferred embodiment, lift mechanism 600 includes lift actuator 610, vertical support shafts 620, bearings 630, and brackets 640. As shown in FIGS. 1-3, vertical supports shafts 620 are disposed on either side of product manifold 100 and are connected to the frame of filling line 20. Bearings 630 are slidably supported on vertical support shafts 620 so that they can translate vertically. Brackets 640 are configured to connect product manifold 100 to bearings 630 that slide along vertical support shafts 620. Lift actuator 610 is preferably a programmable linear servo that attaches to product manifold 100 one end and to the frame of filling line 20 on the other end. Thus, as linear actuator 610 extends and retracts, dispensing apparatus 10 moves up and down with respect to filling line 20. Lift mechanism 600 is preferably adapted to vertically translate dispensing apparatus 10 at speeds of preferably greater than 1 m/s. Although lift mechanism 600 has been described with regard to a preferred embodiment, as may be apparent to one skilled in the art, other structures or configurations may be suitable for moveably connecting product manifold 100 of dispensing apparatus 10 to filling line 20.

### Rotation Mechanism

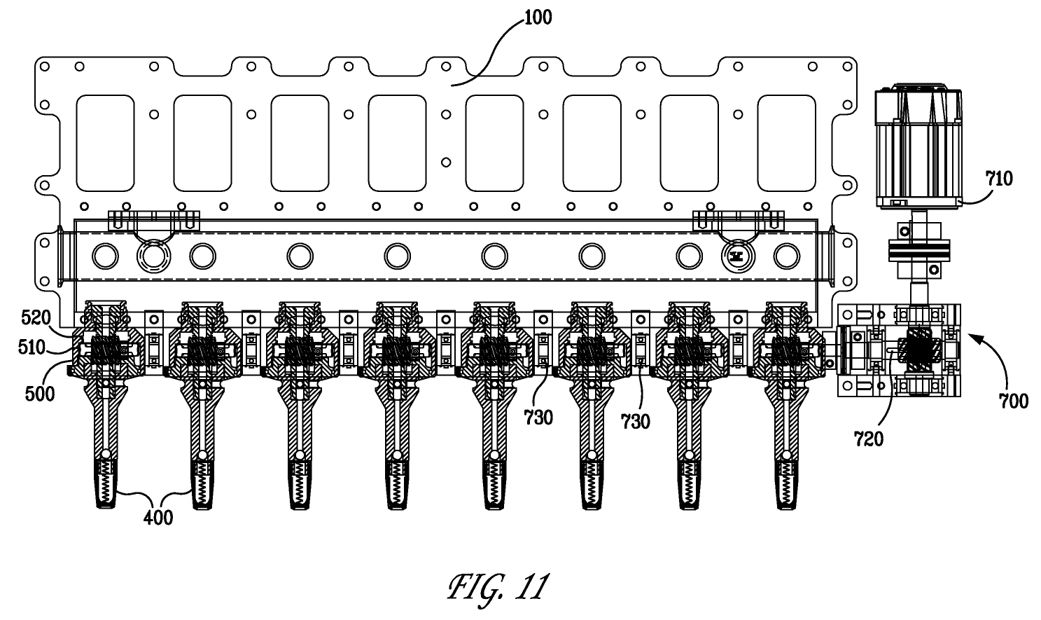

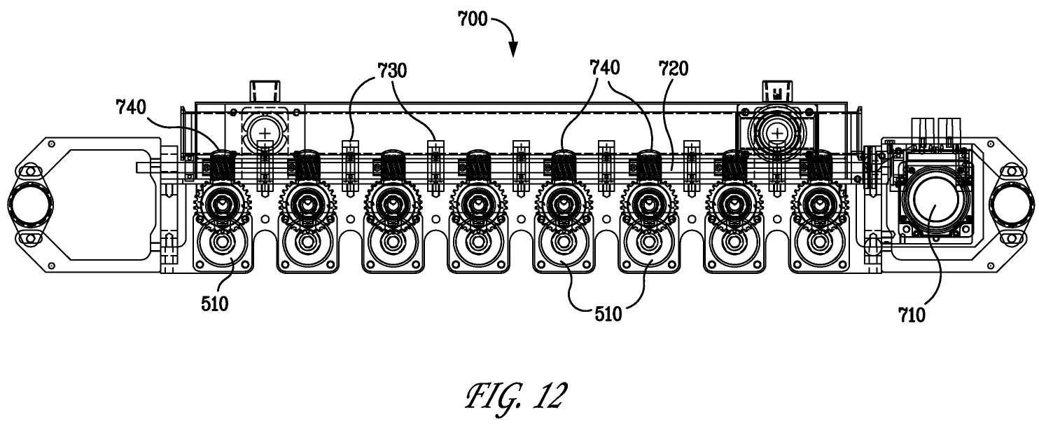

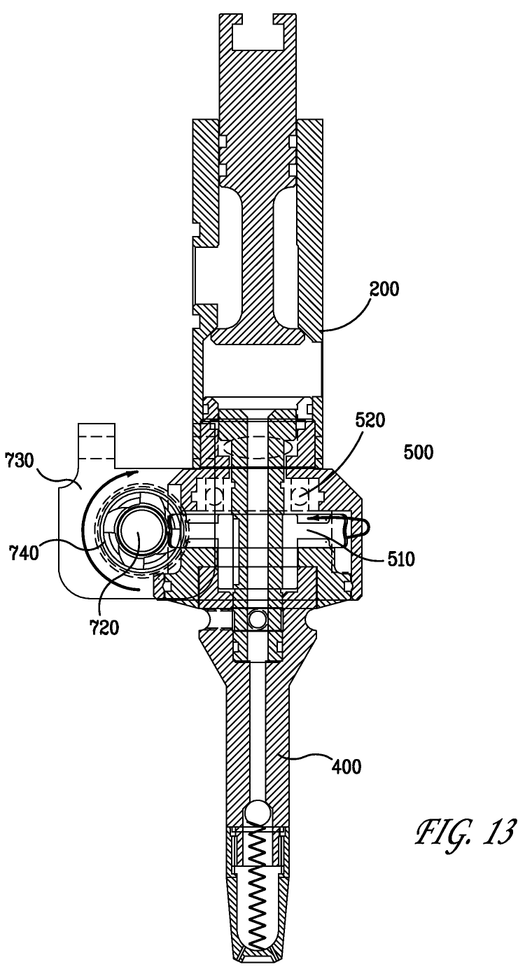

As discussed above, some product configurations may require rotation of nozzles 400. Thus, rotation mechanism 700 may be provided in conjunction with adapter 500 for spinning nozzle 400. In a preferred embodiment, rotation mechanism 700 comprises rotation actuator 710, drive shaft 720, and bearings 730. rotation actuator 710 is preferably a programmable servo that can operate clockwise and counterclockwise. As shown in FIGS. 11 and 12, rotation actuator 710 is supported on product manifold 100 and is operably connected to drive shaft 720 that is supported on product manifold 100 by bearings 730. The portions of drive shaft 720 supported by bearings 730 are smooth, but other portions 740 of drive shaft 720 have worm threads disposed thereon. Worm-thread portions 740 may be integrally formed on drive shaft 720 or may be formed on collars that can be easily attached to and detached from drive shaft 720. Worm-thread portions 740 are configured to engage threads of gears 510 in adapters 500 for spinning nozzles 400. As shown in FIGS. 3 and 13, bearings 730 support drive shaft 720 so that drive shaft 720 and gear 510 of adapter 500 engage when depositor module 200 is mounted on product manifold 100. Also, as shown in FIG. 12, drive shaft 720 extends the length of product manifold 100 so that threaded portions 740 of shaft 720 can engage and drive all of depositor modules 200 mounted on product manifold 100. Thus, rotation mechanism 700 can actuate the spinning of nozzles 400 of dispensing apparatus 10.

### Telescoping Product Supply Tube

Because dispensing apparatus 10 is adapted to be vertically translated with respect to filling line 20, product manifold 100 requires flexible lines to be attached to inlet 124 and outlet 126 for providing the liquid food. Further, these flexible lines need to be temperature controlled to maintain the liquid food at the required temperatures. The temperature-controlled fluid-jacketed lines currently available, however, are very stiff and require long lengths to be flexible. These long lines are impractical on a multi-operation production line. Thus, in a preferred embodiment, fluid-jacketed telescoping tube 800 may be provided for connecting inlet 124 and outlet 126 of product distribution tube 120 in product manifold 100 to a source of pressurized liquid food (e.g. tank or pump) so that liquid food may be circulated through product manifold 100.

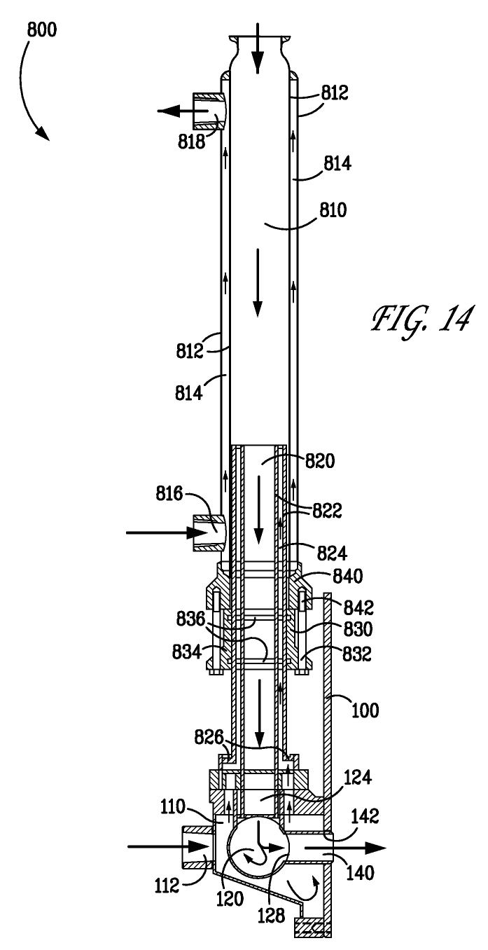

In a preferred embodiment shown in FIG. 14, telescoping tube 800 comprises outer tube 810, inner tube 820, and bearing 830. The upper end of outer tube 810 is adapted to be connected to a liquid food source. As shown, outer tube 810 preferably has a double-wall construction that defines chamber 814 between two walls 812. Also, outer tube 810 comprises fluid-entrance opening 816 and fluid-exit opening 818 that extend from the exterior of outer tube 810 into chamber 814 between double walls 812. fluid-entrance and fluid-exit openings 816, 818 may be connected to a source of temperature-controlled fluid (not shown) and a pump (not shown) so that the temperature-controlled fluid may be circulated throughout chamber 814.

Further, outer tube 810 includes bearing mount 830 that is disposed on the lower end of outer tube 810. Bearing mount 840 may be integrally formed with or welded to outer tube 810. Bearing mount 840 defines holes 842 adapted to receive fasteners (e.g. screws, bolts, etc.) for connecting to bearing 830. Bearing 830 is configured to slidably associate outer and inner tubes 810, 820. bearing 830 defines holes 832 that are adapted to align with holes 842 of bearing mount 840 so that bearing 830 may be attached and sealed against bearing mount 840 with fasteners. Bearing 830 defines inner surface 834 for slidably engaging inner tube 820. Inner surface 834 of bearing 830 has seals 836 that seal against inner tube 820 for preventing liquid food from leaking through inner and outer tubes 820, 810.

As shown, inner tube 820 is disposed inside outer tube 810 and is slidably associated with outer tube 810 by bearing 830. Inner tube 820 preferably has a double-wall construction that defines chamber 824 between two walls 822. Chamber 824 preferably has opening 826 at its lower end for circulating fluid. The lower end of inner tube 820 is adapted to be connected to inlet 124 or outlet 126 of product distribution tube 120 in product manifold 100 so that liquid food may be circulated through product manifold 100. Further, opening 826 at the lower end of chamber 824 of inner tube 820 is configured to be in fluid communication with fluid-jacket chamber 110 of product manifold 100 so that temperature-controlled fluid can be circulated through chamber 824 of inner tube 820.

Thus, fluid-jacketed telescoping tubes 800 may be provided for connecting inlet 124 and outlet 126 of product distribution tube 120 in product manifold 100 to a source of pressurized liquid food (e.g. tank or pump). As dispensing apparatus 10 moves up and down during a filling operation, telescoping tubes 800 expand and contract. Further, the temperatures of the liquid food being delivered through telescoping tubes 800 can be regulated by means of the temperature-controlled fluid flowing through chambers 814, 824 of telescoping tubes 800.

What is claimed is:

1. A depositor module for detachably connecting to a liquid food manifold, comprising:
a first chamber comprising an inlet and an outlet; and
a second chamber connected to the first chamber through a passage;
wherein in a first state, the inlet and the passage are open and the outlet is closed, such that a liquid food may flow in from the inlet, through the first chamber, and into the second chamber;
wherein in a second state, the inlet is closed and the passage and outlet are open, such that a liquid food may flow from the second chamber, through the first chamber, and out through the outlet.

2. The depositor module of claim 1, wherein the first chamber further comprises a valve configured to, in the first state, open the inlet and passage and close the outlet, and in the second state, close the inlet and open the passage and outlet.

3. The depositor module of claim 1, further comprising a controller connected to the valve to actuate the valve between the first and second states.

4. The depositor module of claim 1, wherein the first chamber further comprises a piston configured to, in the first state, create a negative pressure differential to pull liquid food from the inlet, through the first chamber, and into the second chamber, and in the second state, create a positive pressure differential to push liquid food from the second chamber, through the first chamber, and out through the outlet.

5. The depositor module of claim 4, further comprising a controller connected to the piston to actuate the piston between the first and second states.

6. The depositor module of claim 4, further comprising a controller connected to the valve and piston to actuate the valve and piston between the first and second states.

7. The depositor module of claim 4, further comprising a nozzle detachably connected to the outlet.

8. The depositor module of claim 7, further comprising an adapter for detachably connecting the nozzle to the outlet.

9. The depositor module of claim 4, further comprising an interface for detachably connecting the depositor module to the liquid food manifold.

10. The depositor module of claim 4, further comprising a lift mechanism configured to vertically translate the depositor module.

11. The depositor module of claim 10, further comprising a rotation mechanism configured to spin or rotate the nozzle about a vertical axis.

12. The depositor module of claim 10, wherein the controller is further configured to control the vertical translation mechanism to vertically translate the depositor module in sync with the dispensing of the liquid food.

13. The depositor module of claim 11, wherein the controller is further configured to control the rotation mechanism to spin the nozzle in sync with the dispensing of the liquid food.

14. The depositor module of claim 13, further comprising a rotation mechanism configured to spin or rotate the nozzle about a vertical axis, wherein the controller is further configured to control the rotation mechanism to spin the nozzle in sync with the dispensing of the liquid food and the vertical translation of the depositor module.
